(19) United States
(12) Patent Application Publication
(10) Pub. No.: US 2008/0163167 A1
(43) Pub. Date: Jul. 3, 2008

(54) INCORPORATING AN ARBITRARY SCRIPTING LANGUAGE WITH NATIVE SUPPORT FOR JAVA OBJECTS

(75) Inventors: Vsevolod O. Buzinov, Saint-Petersburg (RU); Kirill V. Orlov, Saint-Petersburg (RU); Denis S. Suvorov, Saint-Petersburg (RU); Donald R. Woodward, Monte Sereno, CA (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/618,201

(22) Filed: Dec. 29, 2006

(51) Int. Cl. G06F 9/44

(52) U.S. Cl. 717/115

(57) ABSTRACT

A method, apparatus, and electronic device for executing programming across multiple programming languages are disclosed. The method may include executing an object method invocation using an arbitrary scripting language; and accessing a Java® object through a Java® scripting language interface. The Java® scripting language interface may determine the type of each Java® object, and match it with the appropriate scripting language object, be the object a value, method or class. The Java® scripting language interface may also build a scripting language object using Java® values and methods.

### FIELD OF THE INVENTION

The present invention relates to a method and system for using Java® objects. The present invention further relates to setting up a generic interface to allow any arbitrary scripting language to use Java objects.

### INTRODUCTION

In the early 1990's, Sun Microsystems® developed an object-oriented programming language named Java®. The extreme portability of Java® made it ideal for use by internet websites. The structure of Java® is very similar to such programming languages as C and C++. Java® has become an incredibly popular programming language among internet developers.

A second type of programming language is a scripting language. A scripting language file may be interpreted without conversion to a binary executable file. Scripting languages improve ease of development and allow for multiple types of components to be used simultaneously. Numerous different type of scripting languages exist.

Object-based programming languages, as the name would imply, includes several different programming languages that use of objects in programming. Objects refer to the data structures used by these programming languages. These data structures may include values, such as integers, floats, Booleans (true or false values), strings, or characters. The data structures may be arrays or other matrices. The data structures may include various predetermined methods, or an algorithm for performing a transformation of a value or a set of values. The data structures may also include a class, which is a combination of various values and methods.

A typical scripting language has a collection of built-in primitive types that differ from Java®, usually having a narrower set of options. Usually a scripting language has one numeric type, one string type, and one Boolean type. Thus, during type conversion some type information may be lost. Thus, an efficient method is needed to convert between scripting language and Java® language.

### SUMMARY OF THE INVENTION

A method, apparatus, and electronic device for executing programming across multiple programming languages are disclosed. The method may include executing an object method invocation for a Java® object using an arbitrary scripting language; and accessing the Java® object through a Java® scripting language interface. The Java® scripting language interface may determine the type of each Java® object, and match it with the appropriate scripting language object, be the object a value, method or class. The Java® scripting language interface may also build a scripting language object using Java® values and methods.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates one embodiment of a simplified scheme of a scripting language interacting with a Java® class.

FIG. 2 shows one embodiment of a method of type traversing.

FIG. 3 illustrates one embodiment of a method for setting a property value.

FIG. 4 illustrates one embodiment of a method for accessing a Java® method.

FIG. 5 illustrates in a flowchart one embodiment of a method for executing method lookups.

FIG. 6 illustrates one embodiment of a method for generating a Java® object.

FIG. 7 illustrates a possible configuration of a computer system to act as a mobile system or base station to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device for executing programming across multiple programming languages are disclosed. The method may include executing a Java® object method invocation using an arbitrary scripting language; and accessing the Java® object through a Java® scripting language interface. The Java® scripting language interface may determine the type of each Java® object, and match it with the appropriate scripting language object, be the object a value, method or class. The Java® scripting language interface may also build a scripting language object using Java® values and methods.

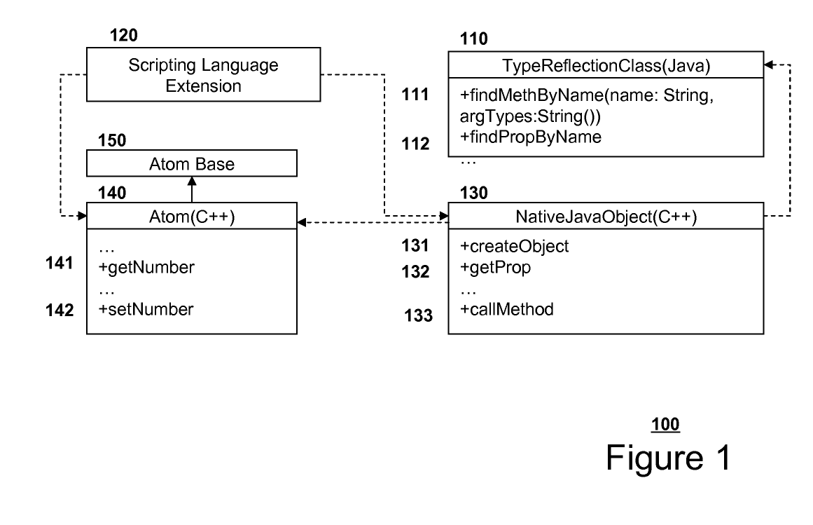

FIG. 1 illustrates one embodiment of a simplified scheme 100 of a scripting language interacting with a Java® class. A pure Java® package 110 may make use of type reflection to find a method 111 or a property 112 by its name. An extension interface 120 of a particular scripting language may be used to create native C or C++ functions. Native C++ code 130 may be used to connect the extension interface 120 to the pure Java® package 110. The native C++ code 130 may include methods to create objects 131, set properties 132, and call methods 133 among other options. To make things generic, an instance 140 of a proxy object 150, called here the Atom object, may hide implementation details of a particular scripting language and provide an independent generic interface for a scripting language type.

The Atom type 150 encapsulates values of all the primitive types of a particular language, including strings, arrays, and objects 130. The arrays may include nested arrays. The Atom objects 130 may be used to represent Java® objects in the script code. The Atom objects 130 may contain a native C++ part that remains to exist as long as the underlying object does. The Atom objects 130 may even exist between different contexts, such as a parameter passed to a method, a return value of a method, and a property assigned to or acquired from a Java® or scripting language object.

The Atom type 150 may be implemented for a particular scripting language. Before producing a method call or getting or setting a property, the scripting language object is marshaled to an Atom object 150. The value that is received as a return value from a method or as a value of a property is in the Atom type 150 and must be converted to a native scripting language type before use.

A generic implementation 140 of the Atom type 150 may be provided in a form of an abstract C++ class template. The class may include a number getter 141 and setter 142 functions for the various possible types available. The base abstract class 140 of the Atom class 150 holds a state property that holds information about its current type. If an attempt is made to retrieve the value of the Atom object by calling a getter of a mismatched type, an exception is thrown.

At least three kinds of type conversion may be performed: conversion from scripting language type (AtomType) to Java® class type (jclass) (a “set property” operation), from jclass to AtomType (a “get property” operation) and from AtomType to a Java® value type (jvalue) (a “call method” operation). All these conversions, although being done in different directions or with different source (the “from” type) and destination (the “to” type) types, share a common stage, called type traversing. Type traversing is the process of determining the type and calling an appropriate callback function to handle it. Type traversing may use a signature argument to set the type of the destination value, as some scripting language types (like the number type) are ambiguous in relation to Java® types (like byte, int, or long types).

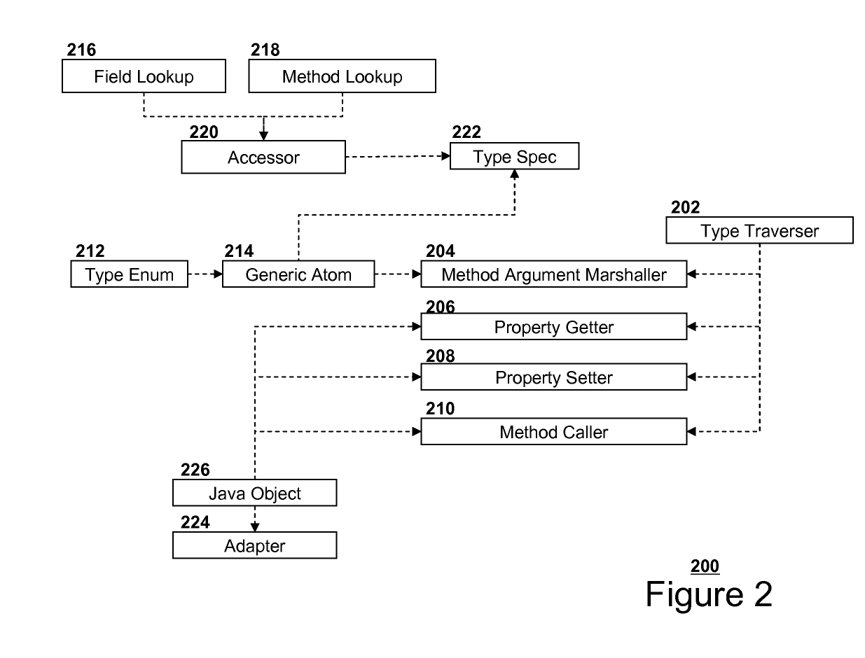

FIG. 2 shows one embodiment of a method 200 of type traversing. A type-traversing interface 202 defines a callback interface to be used in type traversing. Classes for method argument marshaling 204, property getting 206, property setting 208, and method calling 210 may be the implementations of this interface. Given the proper destination and source template arguments to correlate with those of a selected implementation and a signature of the resulting value type as a parameter, the type traversing class 202 may initiate the correct sequence of operations in the implementation as the result of a call to a traverse method.

Since a typical scripting language lacks exact analogs to some of the Java® built-in types, a type hinting mechanism may be used with arguments in method calls. The type hinting is achieved by creating a set of new object types in the scripting languages to serve as wrappers to the value. These new object types may be used in overloaded method calls to specify the exact type to determine the most appropriate method. The name of the type may be used to deduce the desired type. These types may be enumerated 212 in the generic atom 214.

Field lookups 216 and method lookups 218 may be based on the name of the field or method that is looked up. For a method lookup 218, the types of the arguments that are passed to the method may be used to select the most appropriate method amongst overloaded methods. The classes that perform field lookups 216 and method lookups 218 may be written in Java®.

An accessor utility class 220 may be used by both the method lookup 218 and the field lookup 216. The accessor 220 may determine whether the value of the second type is assignable to the value of the first type and add a check if the class can be found within the available classes.

The field lookup 216 may be used to check if the desired field exists in the class, and returns a reference to the field in case of success. The field lookup 216 may make use of the accessor class 220 to check if the value of the type of the field can be assigned to the type desired by the caller.

The method lookup 218 may be used to check if the desired method exists in the class, and returns a reference to the method in case of success. The method lookup 218 may make use of the accessor class 220 to find the best matching method according to the types of the arguments given.

A value is deemed assignable if the types are equal. Both types are checked to determine if they are non-arrays, or arrays of an equal number of dimensions. Both types are equivalent if the first type is of a number type and the second type is one of the integral or floating types, if the first type is of string type and the second type is either of character or of string type, if the first type is of an object type which is assignable from the second type, or if the first type is of object or array type and the second type is null.

A type specification class 222 contains a collection of useful jclass types implemented in both Java® and native code. The type specification class 222 may also define methods to retrieve the element type of an array using type reflection, get the number of dimensions in an array, and construct an array by given element type and number of dimensions.

In native code, the Java® type is always defined by a pairing of jclass and dimensions. The jclass specifies the type and the dimensions specify the number of array dimensions. If the type is not an array type, the dimensions are zero. Thus, before converting a jclass to an atom type, a type traverser 202 implementation, via a generic atom 214, identifies the jclass and dimension pair type by getting the element type of the array and deducing the number of dimensions. If the type is identified as not being an array, the number of dimensions is set to zero. Alternatively, a textual signature may be used to identify a Java® object type.

Runtime class generation is necessary to support dynamic creation of subscriber objects, using a publisher-subscriber design pattern, in order to use them with APIs that are implemented in the way of calling back a function of the given object. Given the name of the super class and/or the list of interfaces to implement, an adapter class 224 is capable of creating a class with an automatically generated name that implements all of the interface and super class methods. When instantiated and linked with a scripting object, the adapter class 224 may create the direct connection between the Java® object class methods and the methods of its associated scripting object in such a way that whenever a particular method is called, the method with the same name of the scripting object is called, given all the arguments passed to the original method. The adapter class may be written in Java® using bytecode generation.

A Java® object interface class 226 may be used to create objects and adapters, access properties, call methods, and handle exceptions. The Java® object interface class 226 may hold a reference to a Java® object. The lifecycle of the Java® object interface class to the lifecycle of the underlying scripting objects.

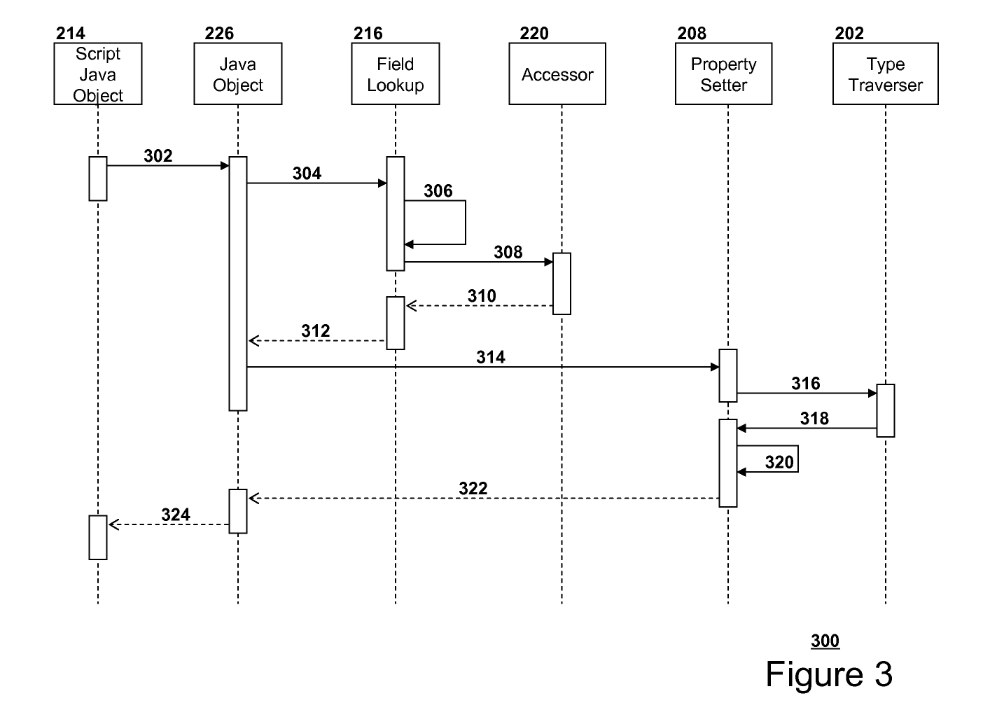

Property getting and setting procedures are similar, differing mainly in direction. In property getting, the jclass value is converted to the AtomType value, while in the property setting procedure the AtomType value is converted to the jclass value. FIG. 3 illustrates one embodiment of a method 300 for setting a property value. While property setting is used in this example, the method for property getting would be similar. A script Java® object 214 may send a request to a Java® object 226 to get or set a property designated by its name (Action 302). The value to set may also be passed. Java® object 226 may try to get the ID of the field by forwarding the request to the field lookup class 216 (Action 304). For a property setting procedure, the value type may also be passed, so that the field lookup class 216 may make an early-stage check of type compatibility. Field lookup class 216 employs type reflection to find the field by name (Action 306). If the field is found, the field lookup class 216 may call the accessor class 220 to check the compatibility of the type given as parameter and the type of the field (Action 308). If applicable, the accessor class 220 may return the field ID and field type to the field lookup class 216 (Action 310), which may return the field ID and field type to the Java® object 226 (Action 312). Then the property setter 208 object may initialize with the field type, field ID, object reference, and value (Action 314). For property getting, instead of the value, the return value of AtomType is used. The property setter 208 may call the type traverser 202 (Action 316). The type traverser 202 may map the field type to the appropriate method of the property setter 208, and may call it back (Action 318). The property setter 208 may then call appropriate versions of a Java® interface function to retrieve the value by its field ID or to set a value (Action 320). The property then returns back to the Java® object 226 (Action 322). For property getting procedures, the value gained as the result of the property getting procedure may be returned (Action 324). For property setting procedures, the Java® object returns nothing. If the appropriate method is overridden by the implementation, if an exception is raised, or if the field is not found, the Java® object also returns nothing.

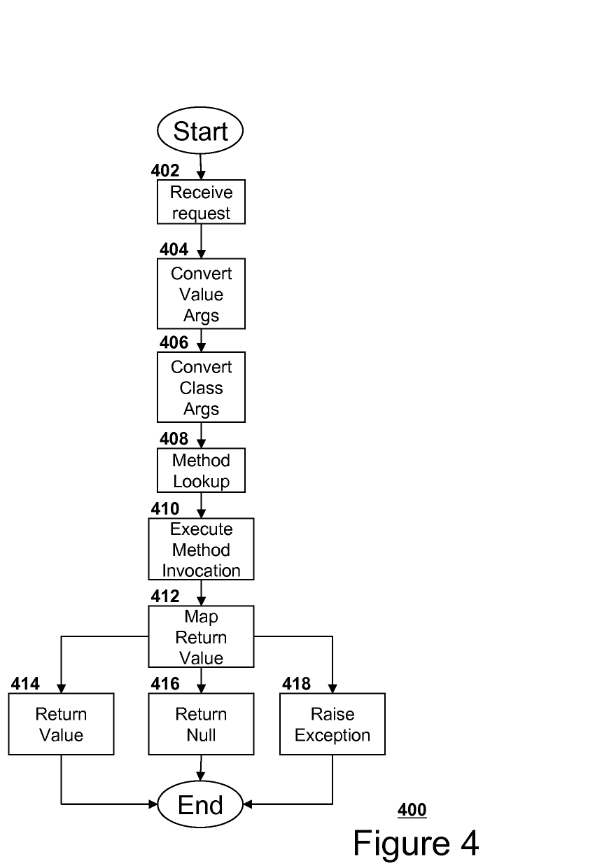

The method invocation workflow follows a similar set of procedures to the property getting and setting procedures. The method invocation uses a different lookup procedure and performs two conversions. FIG. 4 illustrates one embodiment of a method 400 for accessing a Java® method. A Java® object 226 may receive from a script Java® object 214 a request to call a method designated by its name and a list of arguments (Block 402). Java® object 226 may convert AtomType arguments to jvalue types that are suitable for a Java® interface method call function (Block 404). The Java® object 226 then converts the arguments to the method from AtomType to jclass type, which is suitable for the request to method lookup class 218 to find the method (Block 406). The method lookup class 218 performs the method lookup, returning back the method identification, a list of argument types, and a return value type to the Java® object 226 (Block 408). The Java® object 226 uses the method caller class 210 to execute the method invocation (Block 410). Method caller 210 uses the type traverser class 202 to map the type of the desired return value to the corresponding version of Java® interface method type call, which converts the return value to AtomType (Block 412). Java® object 226 may return the value gained as the result of method invocation (Block 414) or a null (Block 416). The Java® object 226 raises an exception if the method was not found (Block 418).

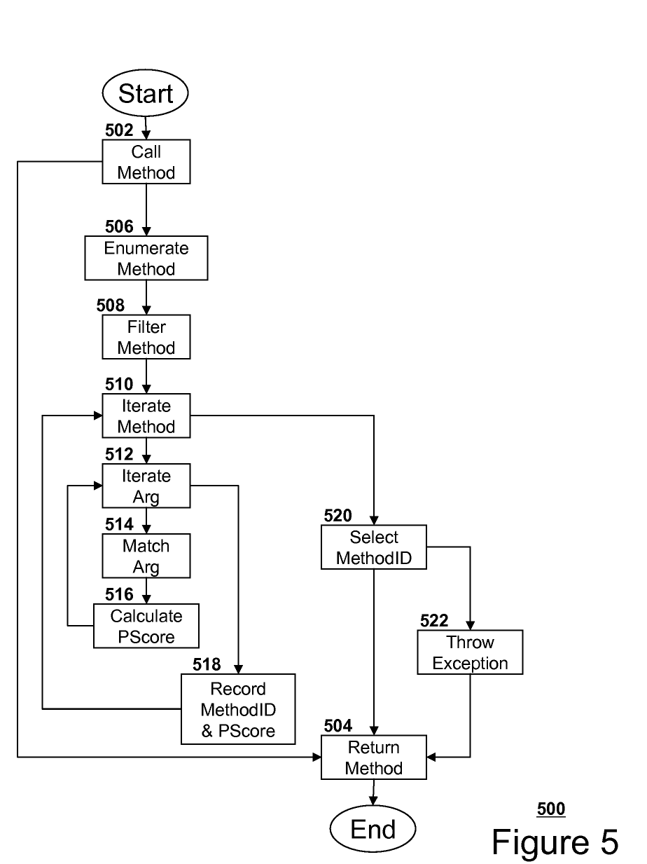

FIG. 5 illustrates in a flowchart one embodiment of a method 500 for executing method lookups 218. Method lookup 218 may attempt a direct call to the method (Block 502), which will succeed if no AtomType-specific types are used in arguments. The direct call may use a pure Java® object reference to store and manipulate the Java® types. The direct call may use the literal method name and list of arguments to perform a fast field and method lookup by employing the Java® reflection application programming interface (API). If the method is found, that method is returned (Block 504). Otherwise, the method lookup class 218 then enumerates all the methods of the class (Block 506), filtering the method candidates by name (Block 508). Iterating though each candidate method (Block 510), the method lookup 218 may iterate through the types of the arguments (Block 512) and employ the accessor class 220 to determine if the types match (Block 514). Types may match if they are the exact same type, if the AtomType is a number and the candidate argument is an integral or floating type; if the AtomType is a string type and the candidate argument is a string or char type; if the AtomType is an object type and the candidate argument is either a superclass or an interface implemented by the AtomType; and if the AtomType is null and the candidate argument type is an array or an object type. A Java® reflection API may also be used to determine whether an expected type and an actual type match. The result of the matching is either no match, or match with the penalty score. The accessor class 220 calculates a penalty score (PScore) when object types are matched against each other (Block 516). The PScore equals the number of classes in the class hierarchy between the first type and the second type. The PScore may distinguish the method amongst overloaded methods that better suit the given arguments. Alternatively, a user may designate which method to use in an overloaded call. When and if all types have been matched, the overall penalty score is accumulated for the method and the method ID is saved in the list along with its penalty score (Block 518). When all candidates have been tested, the method lookup 218 may analyze the list of found methods and select the method with the lowest penalty score (Block 520), returning that method (Block 504). If there are two methods with the same penalty score, an exception is thrown (Block 522).

The adapter class 224 may provide the ability for a scripting language to create a new Java® object 226 that will act as the subscriber in a publisher-subscriber design pattern. Since scripting languages usually contain no actual compilation stage, such an object has to be constructed at run time. The adapter class may define a set of functions to create a class, adding fields and methods to the class. These functions may be implemented using bytecode generation, using Java® Language Specification as a reference.

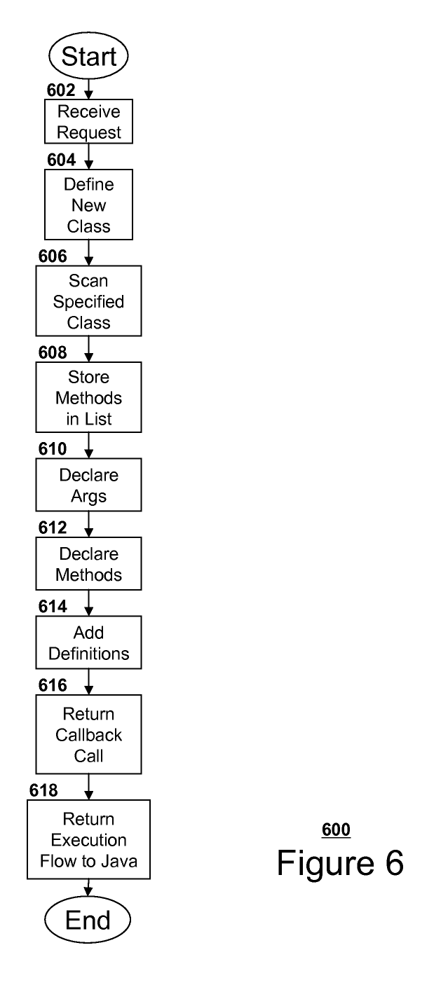

FIG. 6 illustrates one embodiment of a method 600 for generating a Java® object 226. The adapter 224 may receive a request from a scripting object specifying the necessary data (Block 602). This data may include the name of the super class that must be subclassed, the list of the interfaces that the new class must implement, and the instance context. The instance context is a custom field that an implementation will use to locate the object that should be notified about the call to the class. The adapter may define a new class with an automatically generated name that subclasses the defined super class and implements the specified interfaces (Block 604). The adapter 224 scans the specified super class and/or interfaces (Block 606) and stores in a list all the names of the methods they define (Block 608). The arguments to the method may also be saved in the list. The adapter 224 may declare these arguments in the new class as fields (Block 610). The adapter 224 may declare these methods in the new class to override the super class' methods and/or implement interfaces (Block 612). The adapter 224 adds a definition for each of the declared methods (Block 614). Each method may be defined by storing all the arguments in the previously declared fields and making a call to a callback function giving the name of the method and the instance context as arguments to the function. The adapter returns the callback call to the scripting language, which takes the instance context supplied in the notification and finds the corresponding scripting object that handles the request by calling a member function with the same name (Block 616). After the call is done, adapter 224 returns the execution flow back to Java® (Block 618).

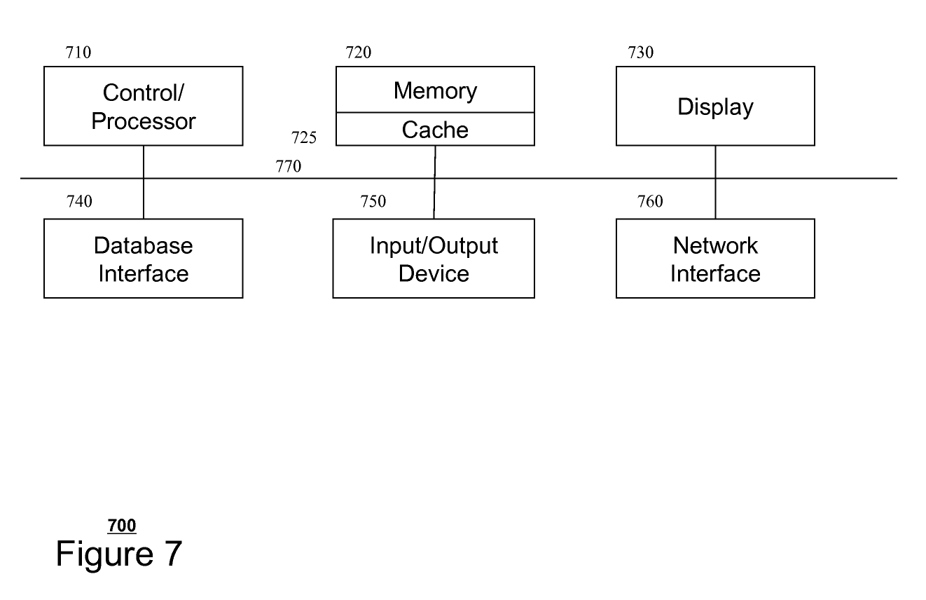

FIG. 7 illustrates a possible configuration of a computer system 700 to act as a device to execute the present invention. The computer system 700 may include a controller/processor 710, a memory 720 with a cache 725, display 730, database interface 740, input/output device interface 750, and network interface 760, connected through bus 770.

The controller/processor 710 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 720 may include volatile and nonvolatile data storage, including one or more electrical, magnetic or optical memories such as a RAM, cache, hard drive, CD-ROM drive, tape drive or removable storage disk. The memory may have a cache 725 to speed access to specific data.

The Input/Output interface 750 may be connected to one or more input devices that may include a keyboard, mouse, pen-operated touch screen or monitor, voice-recognition device, or any other device that accepts input. The Input/Output interface 750 may also be connected to one or more output devices, such as a monitor, printer, disk drive, speakers, or any other device provided to output data.

The network interface 760 may be connected to a communication device, modem, network interface card, a transceiver, or any other device capable of transmitting and receiving signals over a network. The components of the computer system 700 may be connected via an electrical bus 770, for example, or linked wirelessly.

Client software and databases may be accessed by the controller/processor 710 from memory 720 or through the database interface 740, and may include, for example, database applications, word processing applications, the client side of a client/server application such as a billing system, as well as components that embody the decision support functionality of the present invention. The computer system 700 may implement any operating system, such as Windows or UNIX, for example. Client and server software may be written in any programming language, such as ABAP, C, C++, Java® or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. It does not necessarily need to be one system used by all end users. Accordingly, the appended claims and their legal equivalents should only define the invention, rather than any specific examples given.

We claim:

1. A method of executing programming across multiple programming languages, comprising:
executing a Java® object method invocation using an arbitrary scripting language; and
accessing the Java® object through a Java® scripting language interface.

2. The method of claim 1, wherein the Java® scripting language interface uses a pure Java® object reference to access the Java® object.

3. The method of claim 2, further comprising executing a fast object lookup for the Java® object using a Java® reflection application programming interface.

4. The method of claim 1, further comprising determining an object type for the Java® object using the Java® scripting language interface.

5. The method of claim 4, further comprising using a Java® reflection application programming interface to determine if the Java® object matches the scripting language object.

6. The method of claim 1, further comprising matching a scripting language method to a Java® method.

7. The method of claim 6, further comprising comparing a scripting language method name to a Java® method name to determine a match.

8. The method of claim 6, further comprising comparing a set of arguments for the scripting language method to a set of arguments for the Java® method to determine a match.

9. The method of claim 6, further comprising allowing a user to select a Java® method to match to the scripting language method.

10. The method of claim 1, further comprising matching a scripting language field to a Java® field.

11. The method of claim 1, further comprising matching a scripting language class to a Java® class.

12. The method of claim 1, further comprising creating scripting language class using a Java® field or a Java® method.

13. An internet computing apparatus that executes programming across multiple programming languages, comprising:
a memory to store a first series of instructions in an arbitrary scripting language; and
a processor to execute an object method invocation in the first series that accesses a Java® object through a Java® scripting language interface.

14. The internet computing apparatus of claim 13, wherein the processor matches an object type for the Java® object using the Java® scripting language interface.

15. The internet computing apparatus of claim 13, wherein the processor executes an action of a group of actions consisting of matching a scripting language method to a Java® method, matching a scripting language field to a Java® field, or matching a scripting language class to a Java® class.

16. The internet computing apparatus of claim 13, wherein the processor creates scripting language class using a Java® field or a Java® method.

17. An electronic device that executes programming across multiple programming languages, comprising:
a memory to store a first series of instructions in an arbitrary scripting language; and
a processor to execute an object method invocation in the first series that accesses a Java® object through a Java® scripting language interface.

18. The electronic device of claim 17, wherein the processor matches an object type for the Java® object using the Java® scripting language interface.

19. The electronic device of claim 17, wherein the processor executes an action of a group of actions consisting of matching a scripting language method to a Java® method, matching a scripting language field to a Java® field, or matching a scripting language class to a Java® class.

20. The electronic device of claim 17, wherein the processor creates scripting language class using a Java® field or a Java® method.
